(19) United States
(12) Patent Application Publication
(10) Pub. No.: US 2014/0324512 A1
(43) Pub. Date: Oct. 30, 2014

(54) AUTOMATED BUSINESS FUNCTION IMPLEMENTATION ANALYSIS AND ADAPTIVE TRANSACTION INTEGRATION

(71) Applicant: INTERNATIONAL BUSINESS MACHINES CORPORARION, (US)

(72) Inventors: ABDUL ALLAM, Raleigh, NC (US); Kerrie Lamont Holley, San Francisco, CA (US); Claus T. Jensen, Somers, NY (US); Thiam Cheng Lee, Selangor (MY); Chean Fei Yu, Selangor (MY)

(73) Assignee: INTERNATIONAL BUSINESS MACHINES CORPORATION, Armonk, NY (US)

(21) Appl. No.: 13/872,281

(22) Filed: Apr. 29, 2013

(51) Int. Cl. G06Q 10/06

(52) U.S. Cl. CPC G06Q 10/06316
USPC 705/7.26

(57) ABSTRACT

A method, system, and computer program product for creating a business service flow using automated business function implementation analysis and adaptive transaction integration are provided. An implementation of a business service is analyzed to identify a set of transactions used. A set of relationships between transactions is identified, a relationship relates a subset of transactions according to a condition. A set of generic flows is created using a subset of transactions from the set of transactions. A set of adaptive flows is created using a subset of the set of generic flows and a subset of relationships from the set of relationships, an adaptive flow in the set of adaptive flows provides the business service as was provided by the implementation, and the adaptive flow includes program code for responding to the condition by invoking a related transaction based on a relationship used in the adaptive flow.

### TECHNICAL FIELD

The present invention relates generally to a method, system, and computer program product for managing business transactions in a data processing system. More particularly, the present invention relates to a method, system, and computer program product for automated business function implementation analysis and adaptive transaction integration for business transactions in a data processing environment.

### BACKGROUND

Organizations are increasingly focusing on business agility to address rapidly changing business needs. In order to be agile, a business needs to architect and design solutions that are flexible and adaptable to the changing business needs. Flexibility, variability, and adaptiveness are essential in business operations systems in order to meet this business agility goal.

Service-oriented architecture (SOA) is a methodology that is presently used for imparting some flexibility to the business operations systems. For example, in a banking operations system, a business service “create new account” can have variations such as “create savings account” or “create current account.” Furthermore “create savings account” can have its own level of variations such as “create normal account,” such as for a customer above 18 years of age, or “create junior account,” for customer below 18 years of age.

For flexibility and control in the business operations system, business rules to handle the decision making process, such as for the variations in “create new account,” are used in combination with the business service to “create new account.” The combination enables the business to determine whether a certain type of account is permissible for a given customer and to create the account under correct circumstances.

### SUMMARY

The illustrative embodiments provide a method, system, and computer program product for automated business function implementation analysis and adaptive transaction integration. An embodiment includes a method for creating a business service flow using automated business function implementation analysis and adaptive transaction integration. The embodiment includes a computer analyzing an implementation of a business service to identify a set of transactions used in the implementation. The embodiment further includes the computer identifying a set of relationships between transactions, wherein a relationship in the set of relationships relates a subset of transactions in the set of transactions according to a condition. The embodiment further includes the computer creating a set of generic flows using a subset of transactions from the set of transactions. The embodiment further includes the computer creating a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

Another embodiment includes a computer program product for creating a business service flow using automated business function implementation analysis and adaptive transaction integration. The embodiment includes one or more computer-readable tangible storage devices. The embodiment further includes program instructions, stored on at least one of the one or more storage devices, to analyze an implementation of a business service to identify a set of transactions used in the implementation. The embodiment further includes program instructions, stored on at least one of the one or more storage devices, to identify a set of relationships between transactions, wherein a relationship in the set of relationships relates a subset of transactions in the set of transactions according to a condition. The embodiment further includes program instructions, stored on at least one of the one or more storage devices, to create a set of generic flows using a subset of transactions from the set of transactions. The embodiment further includes program instructions, stored on at least one of the one or more storage devices, to create a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

Another embodiment includes a computer system for creating a business service flow using automated business function implementation analysis and adaptive transaction integration. The embodiment includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to analyze an implementation of a business service to identify a set of transactions used in the implementation. The embodiment further includes program instructions, stored on at least one of the one or more storage devices for execution by at least one of the one or more processors via at least one of the one or more memories, to identify a set of relationships between transactions, wherein a relationship in the set of relationships relates a subset of transactions in the set of transactions according to a condition. The embodiment further includes program instructions, stored on at least one of the one or more storage devices for execution by at least one of the one or more processors via at least one of the one or more memories, to create a set of generic flows using a subset of transactions from the set of transactions. The embodiment further includes program instructions, stored on at least one of the one or more storage devices for execution by at least one of the one or more processors via at least one of the one or more memories, to create a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example functionality of an AIT for adaptive transaction integration in accordance with an illustrative embodiment;

FIG. 3A depicts example transaction characteristics, captured in an example tabular form from an existing business operations system implementation in accordance with an illustrative embodiment;

FIG. 4 depicts an example manner of capturing transaction relationships in accordance with an illustrative embodiment;

FIG. 5 depicts a block diagram of an example functionality of an AIT for adaptive transaction integration in accordance with an illustrative embodiment;

FIG. 6 depicts a block diagram of an example functionality of an AIT for adaptive transaction integration in accordance with an illustrative embodiment;

FIG. 7 depicts an example tabulated form of capturing business services, business service to transaction relationships, and business service variability points in accordance with an illustrative embodiment;

FIG. 8 depicts a block diagram of an example functionality of an AIT for adaptive transaction integration in accordance with an illustrative embodiment;

FIG. 9 depicts a block diagram of an example decision service created in accordance with an illustrative embodiment;

FIG. 10 depicts a block diagram of an example functionality of an AIT for adaptive transaction integration in accordance with an illustrative embodiment;

FIG. 11 depicts an example tabulated form of transaction rules in accordance with an illustrative embodiment;

FIG. 12 depicts a block diagram of an example functionality of an AIT for adaptive transaction integration in accordance with an illustrative embodiment;

FIG. 13 depicts an example tabular form of defining base integration patterns in accordance with an illustrative embodiment;

FIG. 14 depicts a block diagram of an example functionality of an AIT for adaptive transaction integration in accordance with an illustrative embodiment; and

FIG. 15 depicts an example tabular form of defining adaptive integration patterns in accordance with an illustrative embodiment.

### DETAILED DESCRIPTION

The illustrative embodiments recognize that designing business operations systems, business transactions, and business rules, using service-oriented architecture in a top-down manner is relatively straightforward, assuming that the desired business behavior is known or well-defined a-priori. The illustrative embodiments also recognize that where business rules (decisions) and transaction variations (variability points) are already codified in existing software systems, in many cases the business operations knowledge that went into designing those systems has been lost or forgotten. Consequently, modifying those systems to accommodate changed or new business needs requires a reverse engineering process, which is not only tedious but also error-prone, inflexible, and not duplicable.

The illustrative embodiments recognize that presently available technology lacks the ability to analyze how and when variations can occur in business transactions in existing business software systems. Presently available technology also cannot automatically extract and externalize rules or decision logic from existing software. Presently available technology therefore also cannot generate dynamically changeable transaction flows with adaptive mechanisms for unforeseen events or occurrences to provide the needed agility to the business operations systems.

The illustrative embodiments used to describe the invention generally address and solve the above-described problems and other problems related to the agility in business operations systems. The illustrative embodiments provide a method, system, and computer program product for automated business function implementation analysis and adaptive transaction integration for business transactions in a data processing environment.

The illustrative embodiments provide a capability for analyzing variability points in existing software systems and generating a corresponding adaptive transaction integration flow, also referred to herein as adaptive integration pattern (AIP) or adaptive mediation flow. The illustrative embodiments separate the business rules into decision services that can be designed and managed independent of the transactions. The illustrative embodiments integrate the independent, or externalized, decision services into the AIP to recreate the business transaction flows of the existing systems.

Thus, an adaptive integration tool according to an illustrative embodiment enables recapturing the business knowledge that is embedded in the existing operational systems and is at risk of being lost over time. An adaptive integration tool according to an illustrative embodiment also enables operational adjustments, variations, optimization, and other manipulations in the business transactions in a flexible manner without manipulating transaction processing code.

An adaptive integration tool can be used for software transformation from monolithic legacy systems to structured systems comprising independent transaction services and decision services. A structured system produced using an adaptive integration tool is much more easily modifiable and maintainable for business agility as compared to the presently available technology.

One example embodiment of an adaptive integration tool performs transaction flow analysis for an existing software system. The adaptive integration tool defines business services and their mapping to the transactions in the existing software system. The adaptive integration tool analyzes and determines business service variability points from the existing business operations system implementation. The adaptive integration tool generates decision services to encapsulate the business rules implemented in the existing implementation. The adaptive integration tool generates an adaptive transaction integration flow or AIP, which arranges the business and decision services in a flow, and recreates or mimics the existing business service functionality as implemented in the existing business operations system. An adaptive integration tool can also reuse all or part of an existing business service functionality implementation in order to recreate or mimic the business service functionality.

An adaptive integration tool further increases the adaptiveness of an AIP by making the AIP dynamically responsive to events during the provision of business services. For example, not every possible event that can arise during a business service can be known or planned for at the time of constructing the adaptive transaction integration flow. The AIP according to an adaptive integration tool incorporates the knowledge of relationships between transactions gleaned from analyzing the existing implementation. The AIP utilizes this knowledge to react to an event, as the event occurs during the provision of business services (dynamically), by invoking a suitable related transaction that can respond to the event.

Thus an adaptive integration tool analyzes variability points in software systems and generates a corresponding AIP that uses externalized decisions services. In one embodiment of the adaptive integration tool, the behavior of the generated AIP is equivalent of the behavior of the existing business operations system implementation.

One embodiment of the adaptive integration tool implements the variability points in the form of decisions tables. In one embodiment of the adaptive integration tool, the AIPs are based on some base integration patterns (BIP or BP) that are industry agnostic, and generalized integration logic for integrating certain generic transactions together.

In one embodiment of the adaptive integration tool, the decisions made by decision services are codified in a suitable rule language for representing rules logic, such as JRule. In one embodiment of the adaptive integration tool, the mediation flow is defined in Business Process Model and Notation (BPMN) or a similarly purposed flow definition language.

In one embodiment of the adaptive integration tool, the processing of the permutations of the variations in a business service is driven by decisions from the decisions services. In one embodiment of the adaptive integration tool, a subsequent flow in AIP is dynamically adapted, modified, or changed, based on the events and decisions occurring earlier in the AIP's flow. In one embodiment of the adaptive integration tool, the AIP includes reversal conditions and other execution behavior, allowing the roll back from a certain point in the flow to a different point in the flow if and when a certain event arises or a condition is met.

The illustrative embodiments are described with respect to certain data records and data sources only as examples. Such data records and data sources or their example attributes are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

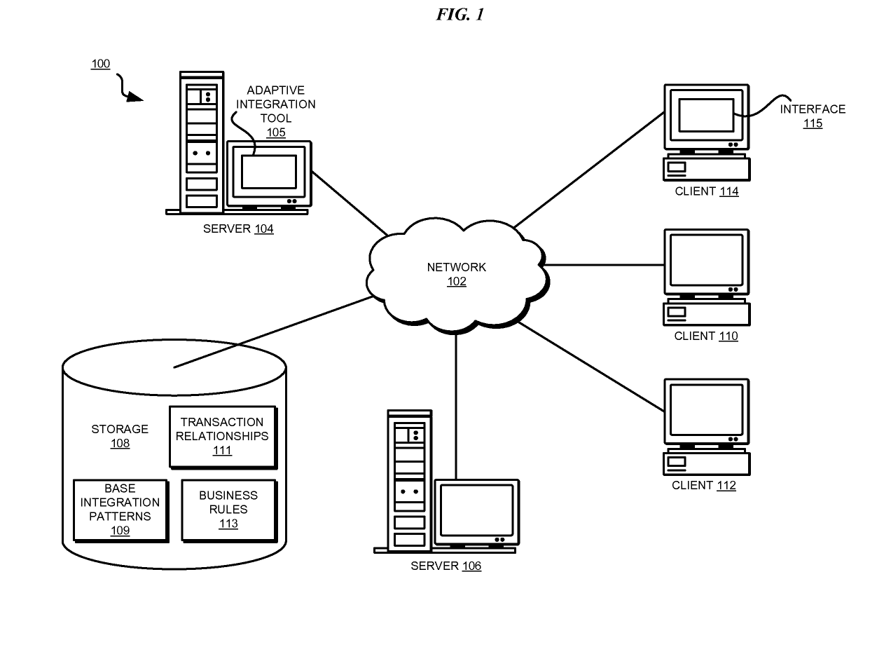

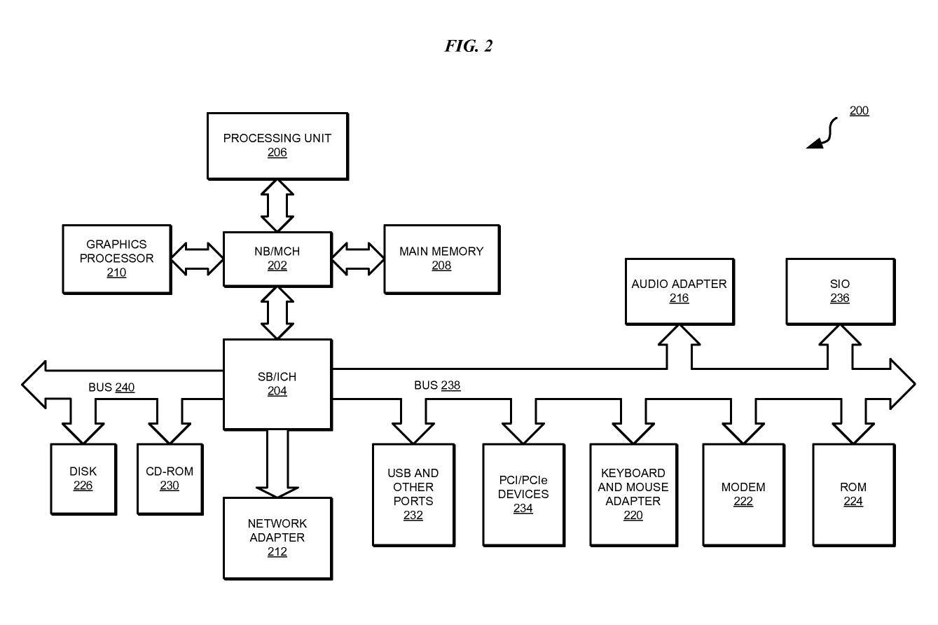

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. For example, adaptive integration tool (AIT) 105 in server 104 includes an implementation of an embodiment described herein. Interface 115 in client 114 allows a user to create a new AIP, or adjust a flow in an AIP automatically created by AIT 105. AIT 105 operates using base integration patterns (BIP) 109 in storage 108, transaction relationships information 111 in storage 108, and business rules 113 in storage 108. For example, in one embodiment, AIT 105 creates and stores BIP 109 in storage 108 or another suitable location based on a previous analysis, as a default set, or as a user-contributed set of base flows. Further as an example, in one embodiment, AIT 105 analyzes an existing business operations system implementation, and stores the transaction relationship information 111 in storage 108 or another location. In one embodiment, AIT 105 creates, stores, and uses decision services that replace, or are based on, business rules 113, in storage 108 or another suitable location.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 114 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as AIT 105, BIP 109, transaction relationships 111, business rules or decision services 113, and interface 115 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

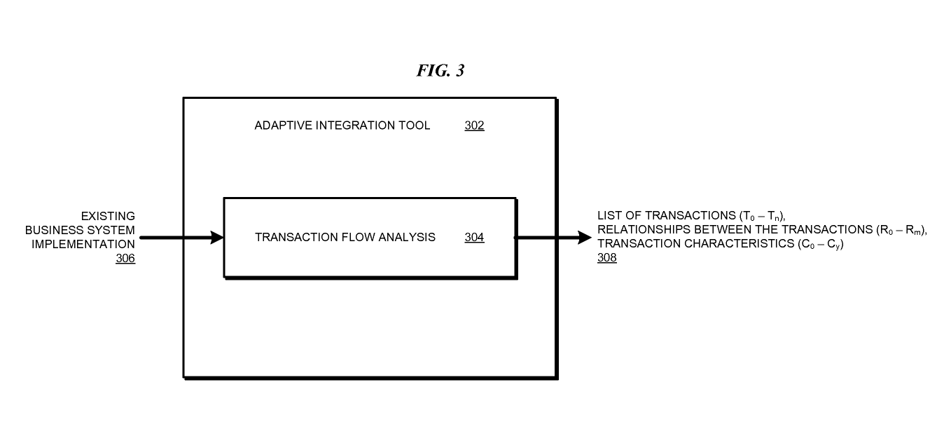

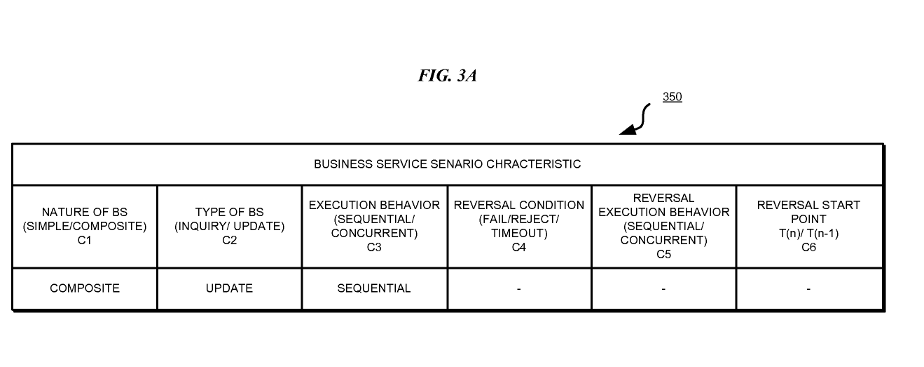

With reference to FIG. 3, this figure depicts a block diagram of an example functionality of an AIT for adaptive transaction integration in accordance with an illustrative embodiment. AIT 302 is an example of AIT 105 in FIG. 1.

AIT 302 includes functionality 304 for performing transaction flow analysis. Functionality 304 receives as input 306, all or a part of an existing business operations system implementation, such as in the form of code, pseudo-code, logic, or specification there for. Using any known tools or techniques for code or logic parsing, functionality 304 produces output 308. Output 308 includes a list of any number of transactions (T), represented herein by labels T₀-Tₙ. Output 308 further includes a list of any number or type of relationships amongst the transactions (R), represented herein by labels R₀-Rₘ. For example, relationships R₀-Rₘ can include temporal relationships or dependencies, even in cases where there is no direct invocation of a transaction, such as in batch processing sequences. Output 308 further includes a list of any number of transaction characteristics (C), represented herein by labels C₀-C_{y}.

A transaction, e.g., “Tₖ” is a business transaction that participates in a business service that is offered from existing business operations system implementation 306. Transaction Tₖ is a transaction whose code can be encapsulated to execute and participate in any business service, using an interface and a set of parameters for that encapsulation.

With reference to FIG. 3A, this figure depicts example transaction characteristics, captured in an example tabular form from an existing business operations system implementation in accordance with an illustrative embodiment. Transaction characteristics C₀-C_{y} depicted in output 308 of FIG. 3 can be captured, collected, organized, or otherwise recorded, such as by functionality 304 in FIG. 3, in any suitable data structure, including but not limited to a table, such as table 350. Table 350 can include any number or type of characteristics, in any number of columns without limitation.

A transaction characteristic, Cₖ, describes a type, dependency, cause, effect, input, result, contingency, condition, or another property of the corresponding transaction. Some example transaction characteristics include, but are not limited to, complexity of transaction (e.g., simple or composite), type of transaction (e.g., inquiry, update, etc.), type of reversal if required in the event of transaction failure or another condition (e.g., sequential or concurrent), abnormal exit type (e.g., time out or error), and reversal start point (another transaction) where the business service processing should reinitiate in case the transaction has to be reversed. Many other transaction characteristics will be apparent from this disclosure to those of ordinary skill in the art and the same are contemplated within the scope of the illustrative embodiments.

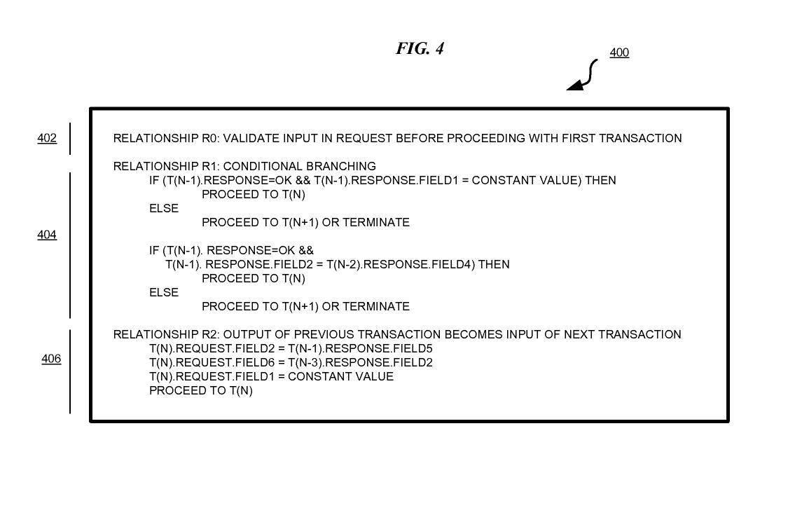

With reference to FIG. 4, this figure depicts an example manner of capturing transaction relationships in accordance with an illustrative embodiment. Transaction relationships R₀-Rₘ depicted in output 308 of FIG. 3 can be captured, collected, organized, or otherwise recorded in any suitable manner, including but not limited to pseudo-code 400.

Only as some non-exhaustive examples, pseudo-code 400 represents a variety of relationships between two or more transactions. For example, section 402 relates a request transaction with a next transaction by specifying that if an input field in the request transaction successfully passes a test, e.g., is validated, the next transaction should be processed or executed.

As another example, section 404 represents a conditional branching based relationship. For example, if-then-else structure in section 404 uses example parameters/attributes/fields of related transactions to transition the processing from one transaction to one or more other transactions, thereby relating the two or more transactions.

As another example, section 406 shows a dependency relationship between two transactions. Only as an example, section 406 shows that a first transaction is related to a second transaction if an output of the first transaction (or a value in the first transaction) is an input to the second transaction (or a value in the second transaction).

These example relationships are not intended to be limiting on the illustrative embodiments. Many other types of relationships between transactions, and many other ways of representing such relationships will be apparent from this disclosure to those of ordinary skill in the art and the same are contemplated within the scope of the illustrative embodiments.

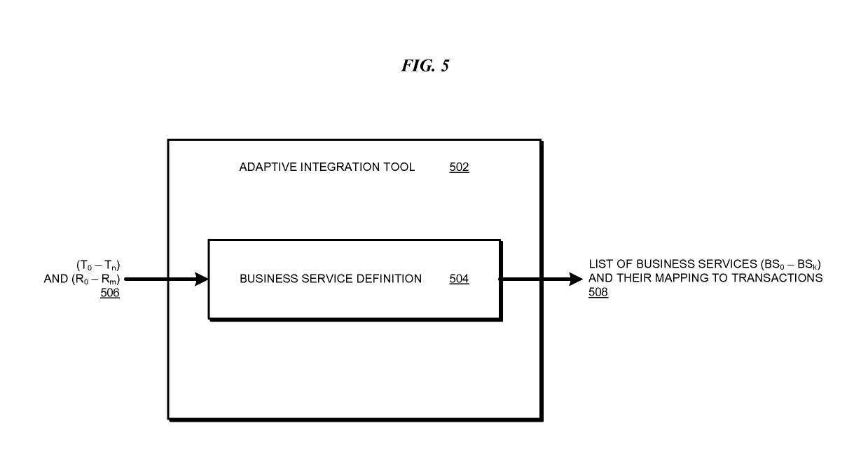

With reference to FIG. 5, this figure depicts a block diagram of an example functionality of an AIT for adaptive transaction integration in accordance with an illustrative embodiment. AIT 502 is an example of AIT 302 in FIG. 3.

AIT 502 includes functionality 504 for defining business services provided from an existing implementation of a business operations system, such as input 306 in FIG. 3. Functionality 504 receives as input 506 all or a part of list of transactions, and transaction relationships, e.g., from output 308 in FIG. 3. Using any known tools or techniques for code or logic parsing, functionality 504 produces output 508. Output 508 includes a list of any number of business services (BS), represented herein by labels BS₀-BSₖ. Output 508 further includes a mapping of the business services to any number or combination of transactions in input 506.

In an example embodiment, functionality 504 generates an initial list of business services by generating one business service definition (including parameters) per transaction in the transaction list of input 506. A user can modify the list of business services, for example, by combining thus-produced business services, splitting a business service into two or more business services and parameter sets, or a combination thereof. An embodiment of functionality 504 keeps track of the mapping the resulting set of business services to the various subsets of transactions in the transaction list of input 506, adjusting the mapping as applicable when business services are combined, split, or otherwise manipulated by the user.

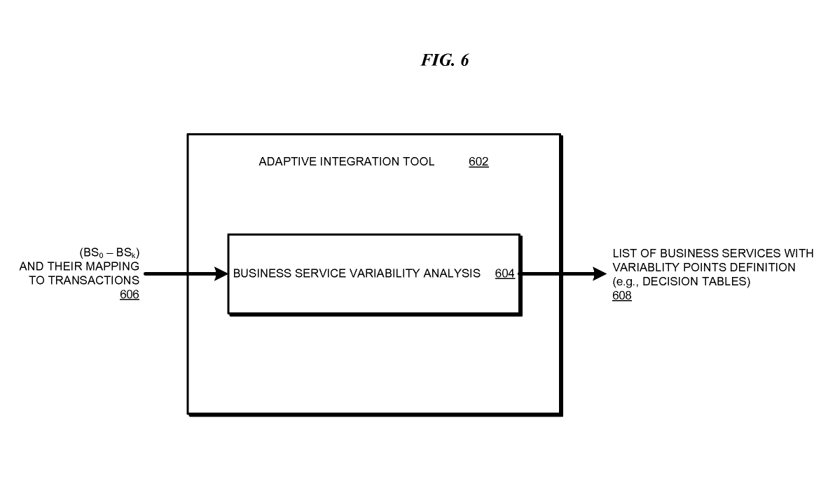

With reference to FIG. 6, this figure depicts a block diagram of an example functionality of an AIT for adaptive transaction integration in accordance with an illustrative embodiment. AIT 602 is an example of AIT 502 in FIG. 5.

AIT 602 includes functionality 604 for performing business service variability analysis on business services supported in an existing business operations system implementation. Functionality 604 receives as input 606 all or a part of list of business services, e.g., from output 508 in FIG. 5. Using any known analytical tools or techniques, functionality 604 produces output 608. Output 608 includes a list of any number of business services having variability points. Output 508 further includes definitions of those variability points, such as in the form of one or more decision tables.

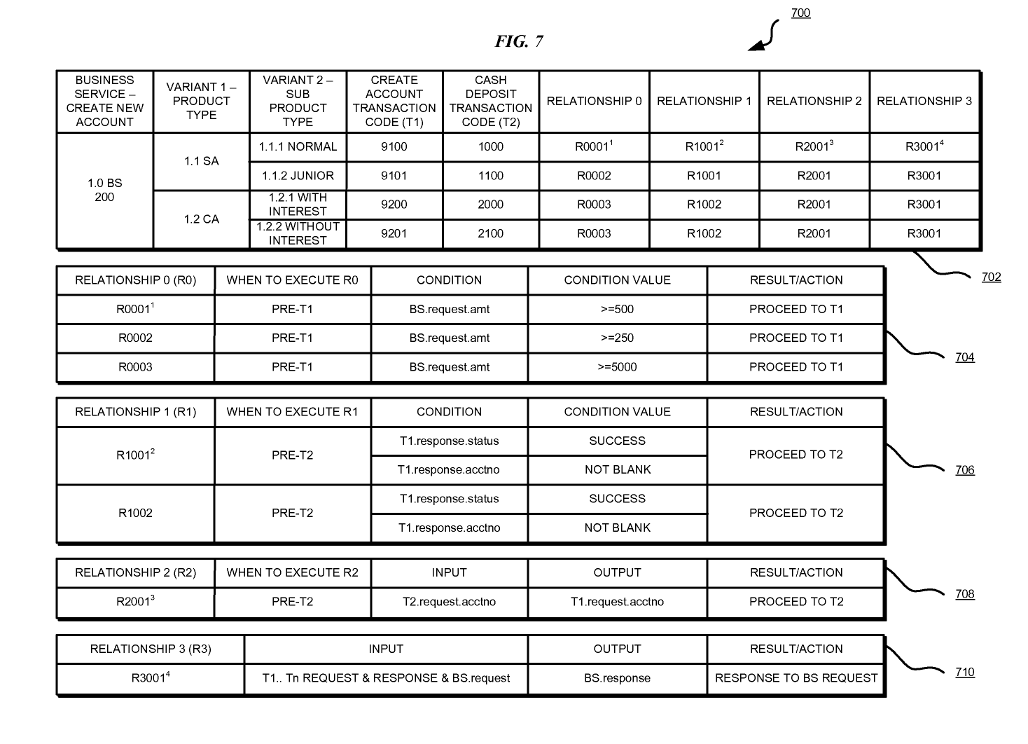

With reference to FIG. 7, this figure depicts an example tabulated form of capturing business services, business service to transaction relationships, and business service variability points in accordance with an illustrative embodiment. Business services BS₀-BSₖ depicted in output 508 of FIG. 5, their relationships to transactions T₀-Tₙ, and their variability points depicted in output 608 in FIG. 6, can be captured, collected, organized, or otherwise recorded by an adaptive integration tool in a table, such as tables 700. Tables 700 are collectively called decision tables, and can include any number or type of business services, variability points, and relationships with transactions, in any number of tables, rows, and columns without limitation.

As an example, table 702 depicts a business service, “create new account,” indexed 1.0, its variants Savings account (SA) indexed 1.1, and checking account (CA) indexed 1.2. Variant 1.1 has further variants “Normal,” indexed 1.1.1, and “Junior,” indexed 1.1.2. A particular variant of the “create account” business service is accomplished by transaction T₁ using transactions identified by code 9100, 9101, 9200, or 9201. Creating an account variant also involves “cash deposit” transaction T₂ identified by code 1000, 1100, 2000, or 2100.

The variants of the business service have different relationships with different transactions, as identified by different relationship codes in table 702. Only as an example and without implying a limitation on the illustrative embodiments, tables 704 and 706 define those relationships that are conditional branching types of relationships. Tables 704 and 706 define when those relationships execute in a transaction flow, which condition and condition value triggers their execution, and what action occurs once they are executed.

Similarly, only as examples, and without implying a limitation on the illustrative embodiments, table 708 defines those relationships that are dependency-based relationships. Table 708 defines when those relationships execute, in which order, and an outcome of the relationship execution. As another example, table 710 defines those relationships that produce some output or result based on some pre-condition, such as the presence of a value in a previous transaction.

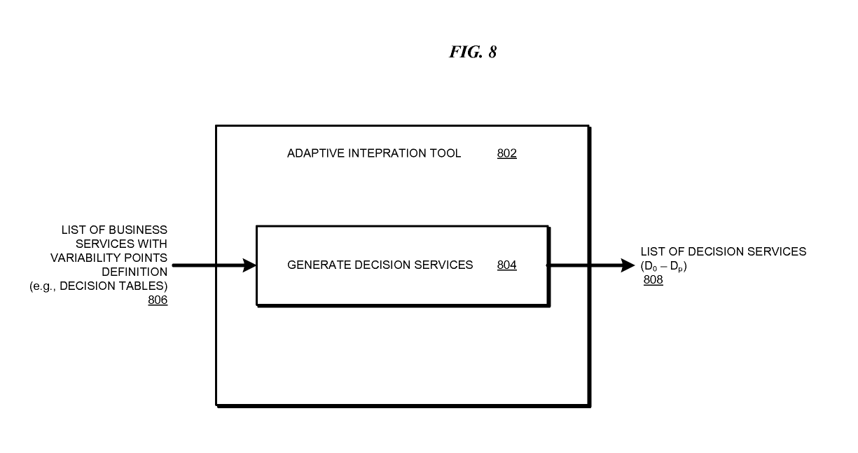

With reference to FIG. 8, this figure depicts a block diagram of an example functionality of an AIT for adaptive transaction integration in accordance with an illustrative embodiment. AIT 802 is an example of AIT 602 in FIG. 6.

AIT 802 includes functionality 804 for creating decision services based on rules employed in the business services identified as supported in an existing business operations system implementation. Functionality 804 receives as input 806 all or a part of list of business services and variability points definitions, e.g., decision tables from output 608 in FIG. 6. Using any known code construction tools or techniques, functionality 804 produces output 808. Output 808 includes a list of any number of decision services, referred to herein as D₀-Dₚ. The decision services of output 808 include invocable interfaces, parameter lists, and decision logic of the business rules encapsulated therein.

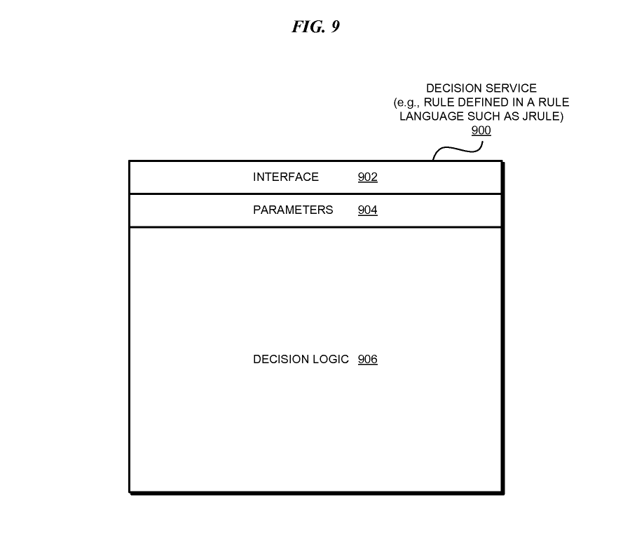

With reference to FIG. 9, this figure depicts a block diagram of an example decision service created in accordance with an illustrative embodiment. Decision service 900 is an example decision service in output 808 in FIG. 8.

Decision service 900 can be implemented in any suitable manner, including but not limited to using a high-level programming language, such as C or C++, or a rule language, such as JRule. Decision service 900 in executable by invocation through interface 902, using optional parameter list 904, to execute decision logic 906, which implements a business rule.

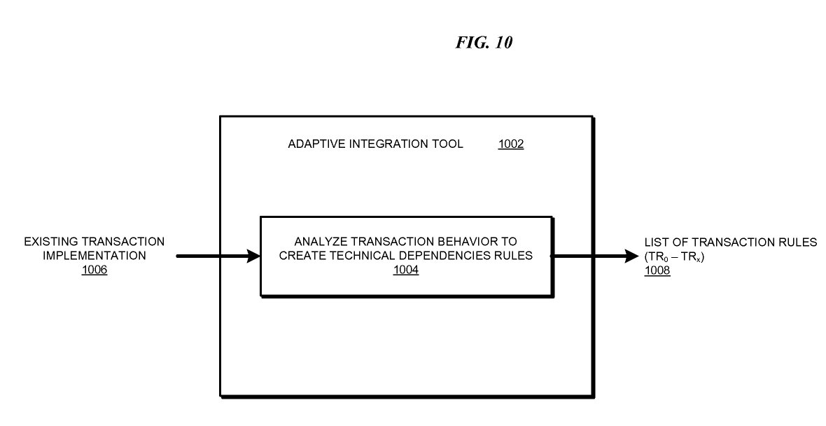

With reference to FIG. 10, this figure depicts a block diagram of an example functionality of an AIT for adaptive transaction integration in accordance with an illustrative embodiment. AIT 1002 is an example of AIT 802 in FIG. 8.

AIT 1002 includes functionality 1004 for analyzing transaction behavior for creating technical dependency rules. Functionality 1004 receives as input 1006 all or a part of existing transactions implementation, such as in an existing business operations system implementation. Using any known code or logic parsing techniques, functionality 1004 produces output 1008. Output 1008 includes a list of any number of transaction rules, referred to herein as TR₀-TRₓ. The transaction rules of output 1008 identify the technological components on which the transactions depend. Some examples of transaction rules in output 1008 include, but are not limited to, communication protocols used, encryption used, queue names, target names, destination storage names, service identifier, service call invocation description, API calls, port numbers, atomic transaction identifier, application end points, and any other similarly purposed technical information about a transaction.

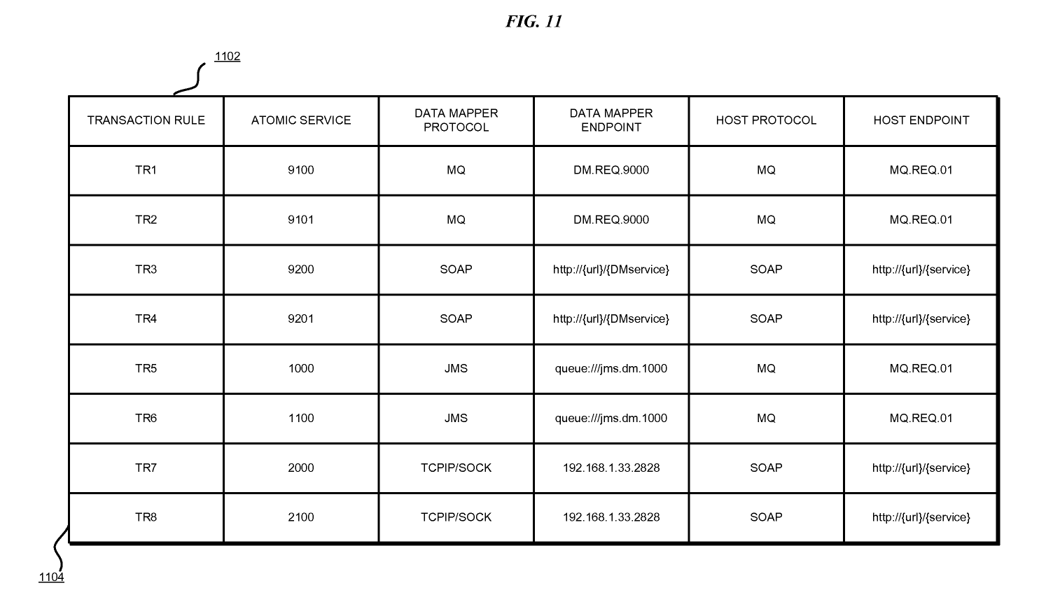

With reference to FIG. 11, this figure depicts an example tabulated form of transaction rules in accordance with an illustrative embodiment. Transaction rules TR₁-TR₈ in table 1102 are examples of transaction rules in output 1008 in FIG. 10.

As an example, table 1102 depicts transaction rule TR₈ as using a service identified by number 2100. Service 2100 is an atomic operation. For example, row 1104 shows that TR₈ uses a data mapper application, which is accessed using TCP/IP socket at IP address 192.168.1.33 at port 2828. Tr₈ operates as service 2100 and is accessed at host endpoint “http://{url}/{service}” address using host protocol SOAP. Other transaction rules are also defined in a similar manner in table 1102.

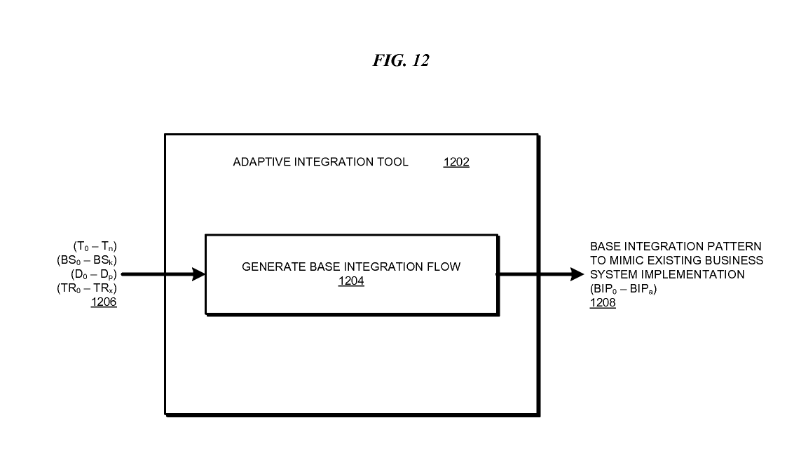

With reference to FIG. 12, this figure depicts a block diagram of an example functionality of an AIT for adaptive transaction integration in accordance with an illustrative embodiment. AIT 1202 is an example of AIT 1002 in FIG. 10.

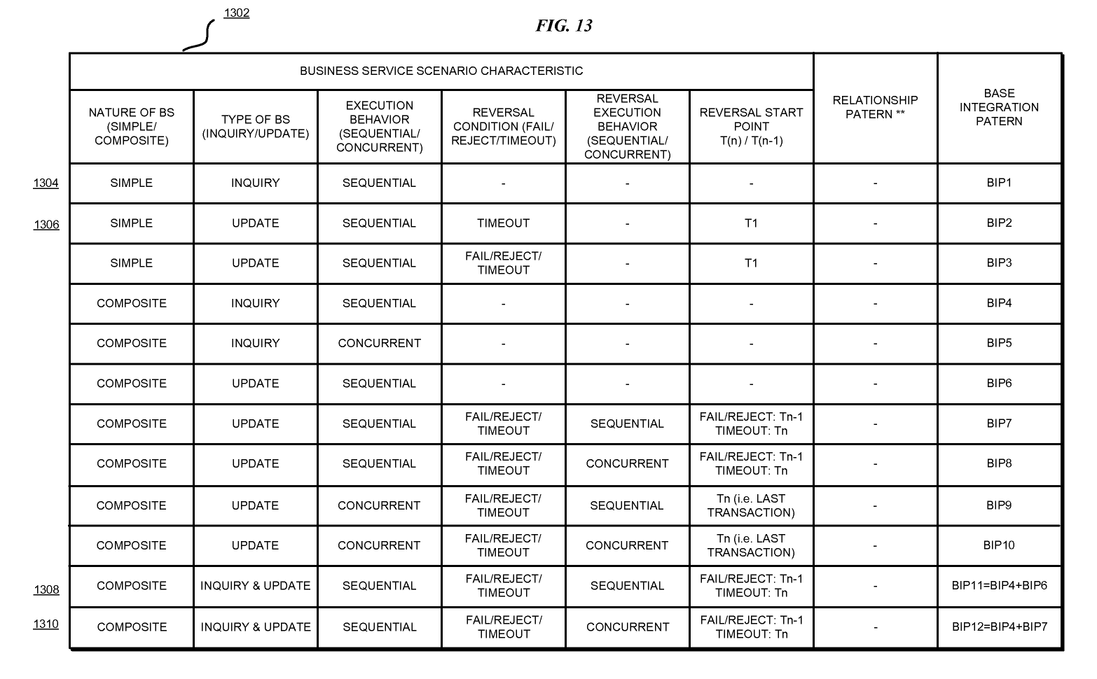

AIT 1202 includes functionality 1204 for generating base integration patterns or flows, such as BIP 109 in FIG. 1. Functionality 1204 receives as input 1206 all or a part of transactions T₀-Tₙ, business services BS₀-BSₖ, Decision services D₀-Dₚ, and transaction rules TR₀-TRₓ produced as outputs of the various functionalities described in other figures herein. Using any known code or logic parsing techniques and analytical techniques in the manner described with respect to FIG. 13, functionality 1204 produces output 1208. Output 1208 includes a list of any number of BIPs that mimic the existing business operations system implementation, referred to herein as BIP₀-BIPₐ.

With reference to FIG. 13, this figure depicts an example tabular form of defining base integration patterns in accordance with an illustrative embodiment. A BIP in table 1302 is produced as output 1208 in FIG. 12.

A BIP in table 1302 is a representation of a certain combination of transaction characteristics occurring in a given business operations system implementation, as described in FIG. 3A. For example, a BIP depends on some combination of transaction characteristics according to the formula as follows—

BIPₓ=Occurrence of ((C1ₛᵢₘₚₗₑ,C1_{composite})+(C2_{inquiry},C2_{update})+(C3_{sequential},C3_{concurrent})+(C4_{fail},C4_{reject},C4ₜᵢₘₑₒᵤₜ)+(C5_{sequential},C5_{concurrent})+(C6_{Tn},C6_{Tn-1}))

Accordingly, an example BIP, BIP₁, may be,

BIP₁=C1_{simple+C}2_{inquiry}+C3_{sequential}

This example BIP is represented in row 1304.

Another example BIP, BIP₂, may be,

BIP₂=C1_{simple+C}2_{update}+C3_{sequential}+C4ₜᵢₘₑₒᵤₜ

This example BIP is represented in row 1306. Row 1306 further indicates that the reversal starting point corresponding to C4ₜᵢₘₑₒᵤₜ is transaction T₁.

Any number of BIPs can be represented in this manner in table 1302. Furthermore, a BIP in table 1302 can be represented as a combination of other BIPs in table 1302. For example, row 1308 indicates that BIP₁₁ is a combination of BIP₄+BIP₆. Similarly row 1310 indicates that BIP₁₂ is a combination of BIP₄+BIP₇.

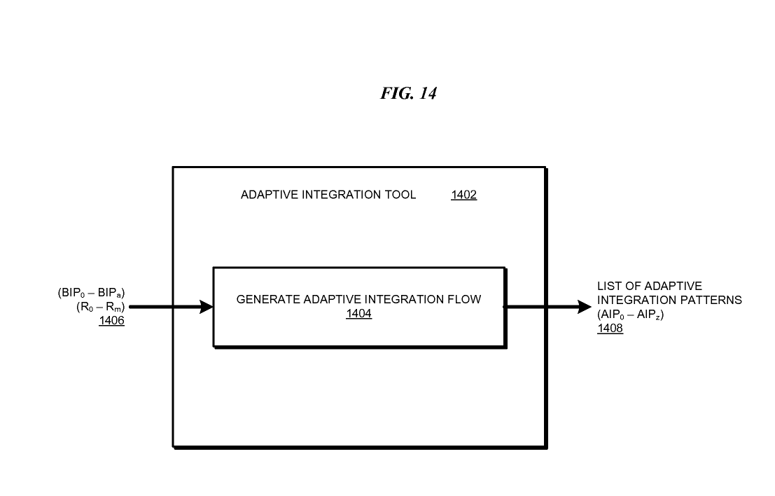

With reference to FIG. 14, this figure depicts a block diagram of an example functionality of an AIT for adaptive transaction integration in accordance with an illustrative embodiment. AIT 1402 is an example of AIT 1202 in FIG. 12.

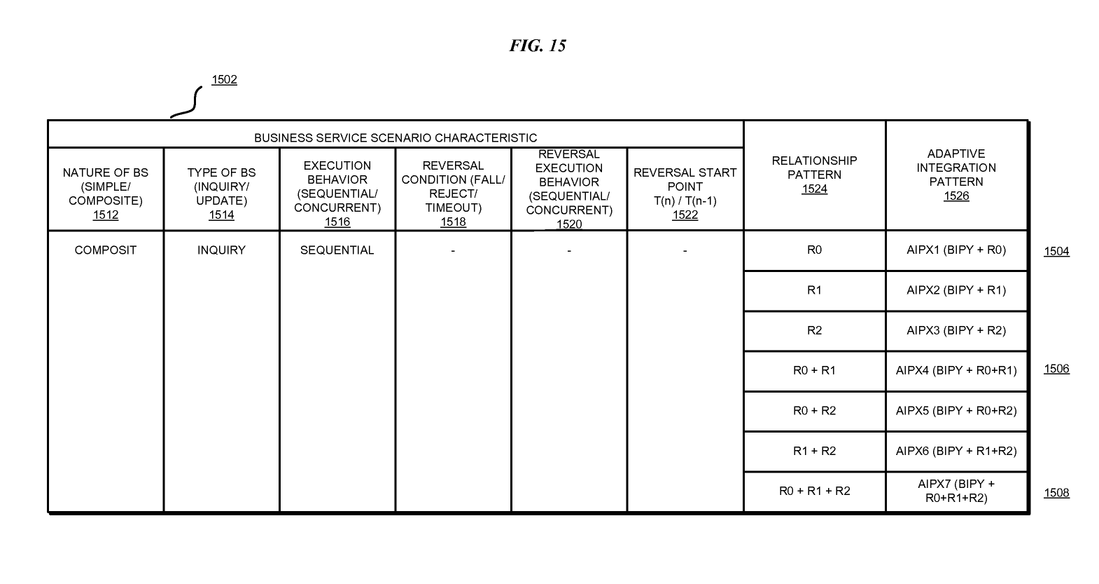

AIT 1402 includes functionality 1404 for generating adaptive integration patterns or flows. Functionality 1404 receives as input 1406 all or a part of BIPs, BIP₀-BIPₐ, from output 1208 in FIG. 12. Using any combination of known code or logic parsing techniques and analytical techniques on table 1302 in FIG. 13, functionality 1404 produces output 1408. Output 1408 includes a list of any number of AIPs, referred to herein as AIP₀-AIP_{z}. As described in FIG. 15, AIPs in output 1408 adaptively integrate the BIPs of table 1302 according to the transaction relationships identified earlier.

With reference to FIG. 15, this figure depicts an example tabular form of defining adaptive integration patterns in accordance with an illustrative embodiment. An AIP in table 1502 is produced as output 1408 in FIG. 14.

An AIP in table 1502 is a representation of a certain combination of BIPs and transaction relationships. For example, an AIP depends on one or more BIPs of table 1302 in FIG. 13, and one or more relationships amongst the transactions in those one or more BIPs. Furthermore, different variations of an AIP might exist owing to the variants of the business services, as described earlier. Generally, an n-th variation of an AIP, AIPₓ, can be expressed in terms of one or more BIPs, BIP_{y} and one or more transaction relationships, R₀-Rₘ, according to the formula as follows—

AIPₓₙ=BIP_{y}+Occurrence of (R₀, . . . ,Rₘ)

An example AIP, AIPₓ₁, may be dependent upon BIP_{y} and relationship R₀. This example AIP is represented in row 1504. Accordingly, row 1504 indicates that the AIP in that row is dependent upon the BIP according to columns 1512-1522, is dependent upon relationship R₀ in column 1524, and provides in column 1526 that the AIP is formed as

AIPₓ₁=BIP_{y}+R₀

Another example AIP, AIPₓ₄, may be dependent upon BIP_{y} and relationships R₀ and R₁. This example AIP is represented in row 1506. Accordingly, row 1506 indicates that the AIP in that row is dependent upon the BIP according to columns 1512-1522, is dependent upon relationships R₀ and R₁ in column 1524, and provides in column 1526 that the AIP is formed as

AIPₓ₄=BIP_{y}+R₀+R₁

Another example AIP, AIPₓ₇, may be dependent upon BIP_{y} and relationship R₀, R₁, and R₂. This example AIP is represented in row 1508. Accordingly, row 1508 indicates that the AIP in that row is dependent upon the BIP according to columns 1512-1522, is dependent upon relationship R₀, R₁, and R₂ in column 1524, and provides in column 1526 that the AIP is formed as

AIPₓ₇=BIP_{y}+R₀+R₁+R₂

The block diagrams in the Figures illustrate the architecture, functionality, and operation of possible implementations of systems, methods, and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams illustration, and combinations of blocks in the block diagrams illustration, can be implemented by special purpose hardware-based systems that perform the specified functions or acts, or combinations of special purpose hardware and computer instructions.

Thus, a computer implemented method, system, and computer program product are provided in the illustrative embodiments for automated business function implementation analysis and adaptive transaction integration for business services in a data processing environment. Using an adaptive integration tool according to an embodiment, an existing implementation of the business services can be automatically analyzed and broken down into core transactions that have certain characteristics, relationships between those transactions, and decision services for handling business service variants.

An adaptive integration tool according to an embodiment further creates generic or base integration between the identified transactions that can be reused for providing the business services in a variety of circumstances. An adaptive integration tool according to an embodiment builds adaptive transaction integration using the base integration and specific relationships between the transactions in the given environment. An adaptive integration tool according to an embodiment auto-generates an adaptive mediation flow based on an automated analysis of existing software. Present workflows that integrate functions and logic in a particular order cannot automatically generate those functions, that logic, or that ordering. Thus, an adaptive integration tool according to an embodiment offers non-trivial advancement over workflow engines, which only execute an externally pre-formulated fixed sequence of functions and logic.

Thus, an adaptive integration tool according to an embodiment creates a flexible way of creating or re-creating a given business service. The flexible way of creating the business service compartmentalizes the logic of the business services into reusable and easily modifiable components. The adaptive integration tool arranges the reusable components in a flow that can be changed easily to adapt to changing business needs.

The flow further enables the data processing environment to dynamically respond to events that could not be planned-for ahead of their occurrence. The dynamic response characteristic is a property of the relationships between the compartmentalized transactions used in the flow.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of methods, apparatus (systems) and computer program products according to embodiments of the invention. It will be understood that each block of the block diagrams, and combinations of blocks in the block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for creating a business service flow using automated business function implementation analysis and adaptive transaction integration, the method comprising:
a computer analyzing an implementation of a business service to identify a set of transactions used in the implementation;
the computer identifying a set of relationships between transactions, wherein a relationship in the set of relationships relates a subset of transactions in the set of transactions according to a condition;
the computer creating a set of generic flows using a subset of transactions from the set of transactions; and
the computer creating a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

2. The method of claim 1, further comprising:
the computer identifying a set of rules used in the implementation of the business service;
the computer creating a set of reusable services corresponding to the set of rules; and
the computer including a reusable service from the set of reusable services in the adaptive flow.

3. The method of claim 2, wherein the reusable service corresponds to a combination of rules in the set of rules, and wherein the combination of rules omits responding to the condition.

4. The method of claim 1, further comprising:
the computer identifying a set of characteristics associated with each transaction in the set of transactions; and
the computer arranging a transaction from the subset of transactions in a generic flow in the set of generic flows according to a subset of characteristics of the transaction.

5. The method of claim 4, wherein the transactions in the subset of transactions, and the generic flow, are each reusable in a second business service, and wherein the implementation omits the second business service.

6. The method of claim 1, further comprising:
the computer implementing a transaction in the set of transactions as a reusable component.

7. The method of claim 1, further comprising:
the computer identifying a set of technological information associated with a transaction in the set of transactions; and
the computer using the technological information to select the transaction as a member of the subset of transactions.

8. A computer program product comprising one or more computer-readable tangible storage devices and computer-readable program instructions which are stored on the one or more storage devices and when executed by one or more processors, perform the method of claim 1.

9. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

10. A computer program product for creating a business service flow using automated business function implementation analysis and adaptive transaction integration, the computer program product comprising:
one or more computer-readable tangible storage devices;
program instructions, stored on at least one of the one or more storage devices, to analyze an implementation of a business service to identify a set of transactions used in the implementation;
program instructions, stored on at least one of the one or more storage devices, to identify a set of relationships between transactions, wherein a relationship in the set of relationships relates a subset of transactions in the set of transactions according to a condition;
program instructions, stored on at least one of the one or more storage devices, to create a set of generic flows using a subset of transactions from the set of transactions; and
program instructions, stored on at least one of the one or more storage devices, to create a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

11. The computer program product of claim 10, further comprising:
program instructions, stored on at least one of the one or more storage devices, to identify a set of rules used in the implementation of the business service;
program instructions, stored on at least one of the one or more storage devices, to create a set of reusable services corresponding to the set of rules; and
program instructions, stored on at least one of the one or more storage devices, to include a reusable service from the set of reusable services in the adaptive flow.

12. The computer program product of claim 11, wherein the reusable service corresponds to a combination of rules in the set of rules, and wherein the combination of rules omits responding to the condition.

13. The computer program product of claim 10, further comprising:
program instructions, stored on at least one of the one or more storage devices, to identify a set of characteristics associated with each transaction in the set of transactions; and
program instructions, stored on at least one of the one or more storage devices, to arrange a transaction from the subset of transactions in a generic flow in the set of generic flows according to a subset of characteristics of the transaction.

14. The computer program product of claim 13, wherein the transactions in the subset of transactions, and the generic flow, are each reusable in a second business service, and wherein the implementation omits the second business service.

15. The computer program product of claim 10, further comprising:
program instructions, stored on at least one of the one or more storage devices, to implement a transaction in the set of transactions as a reusable component.

16. The computer program product of claim 10, further comprising:
program instructions, stored on at least one of the one or more storage devices, to identify a set of technological information associated with a transaction in the set of transactions; and
program instructions, stored on at least one of the one or more storage devices, to use the technological information to select the transaction as a member of the subset of transactions.

17. A computer system for creating a business service flow using automated business function implementation analysis and adaptive transaction integration, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to analyze an implementation of a business service to identify a set of transactions used in the implementation;
program instructions, stored on at least one of the one or more storage devices for execution by at least one of the one or more processors via at least one of the one or more memories, to identify a set of relationships between transactions, wherein a relationship in the set of relationships relates a subset of transactions in the set of transactions according to a condition;
program instructions, stored on at least one of the one or more storage devices for execution by at least one of the one or more processors via at least one of the one or more memories, to create a set of generic flows using a subset of transactions from the set of transactions; and
program instructions, stored on at least one of the one or more storage devices for execution by at least one of the one or more processors via at least one of the one or more memories, to create a set of adaptive flows using a subset of the set of generic flows and a subset of relationships from the set of relationships, wherein an adaptive flow in the set of adaptive flows provides the business service as was provided by the implementation, and wherein the adaptive flow includes program code for responding to the condition by invoking a related transaction based on a relationship used in the adaptive flow.

18. The computer system of claim 17, further comprising:
program instructions, stored on at least one of the one or more storage devices for execution by at least one of the one or more processors via at least one of the one or more memories, to identify a set of rules used in the implementation of the business service;
program instructions, stored on at least one of the one or more storage devices for execution by at least one of the one or more processors via at least one of the one or more memories, to create a set of reusable services corresponding to the set of rules; and
program instructions, stored on at least one of the one or more storage devices for execution by at least one of the one or more processors via at least one of the one or more memories, to include a reusable service from the set of reusable services in the adaptive flow.

19. The computer system of claim 18, wherein the reusable service corresponds to a combination of rules in the set of rules, and wherein the combination of rules omits responding to the condition.

20. The computer system of claim 17, further comprising:
program instructions, stored on at least one of the one or more storage devices for execution by at least one of the one or more processors via at least one of the one or more memories, to identify a set of characteristics associated with each transaction in the set of transactions; and
program instructions, stored on at least one of the one or more storage devices for execution by at least one of the one or more processors via at least one of the one or more memories, to arrange a transaction from the subset of transactions in a generic flow in the set of generic flows according to a subset of characteristics of the transaction.
